(19) United States
(12) Patent Application Publication
(10) Pub. No.: US 2019/0169885 A1
(43) Pub. Date: Jun. 6, 2019

(54) VEHICLE DOOR LOCK DEVICE

(71) Applicant: AISIN SEIKI KABUSHIKI KAISHA, Kariya-shi (JP)

(72) Inventors: Toshio Machida, Toyota-shi (JP); Junji Yamaguchi, Chiryu-shi (JP); Yasuhiro Nagaya, Nishio-shi (JP)

(73) Assignee: AISIN SEIKI KABUSHIKI KAISHA, Kariya-shi (JP)

(21) Appl. No.: 16/207,270

(22) Filed: Dec. 3, 2018

(30) Foreign Application Priority Data
Dec. 6, 2017 (JP) 2017-234534

(51) Int. Cl. E05B 79/04; E05B 85/26; E05B 85/04; E05B 85/24; E05B 83/40

(52) U.S. Cl. CPC E05B 79/04; E05B 85/26; E05B 83/40; E05B 85/243; E05B 85/045

(57) ABSTRACT

A vehicle door lock device includes: a latch mechanism engaged with a striker provided on a vehicle body; and a bracket supporting the latch mechanism on a door of a vehicle. The bracket includes a base plate including a latch holding portion holding the latch mechanism and fixed to the door, and an extension plate extending in a direction intersecting the latch holding portion. The extension plate includes a fastening hole for fastening the extension plate to the door in a thickness direction of the door, a first bead-shaped portion extending in a direction in which the extension plate extends, and a second bead-shaped portion extending in a direction intersecting the first bead-shaped portion. A plurality of the first bead-shaped portions and a plurality of the second bead-shaped portions are arranged in a lattice pattern.

### CROSS REFERENCE TO RELATED APPLICATIONS

This application is based on and claims priority under 35 U.S.C. § 119 to Japanese Patent Application 2017-234534, filed on Dec. 6, 2017, the entire contents of which are incorporated herein by reference.

### TECHNICAL FIELD

The disclosure relates to a vehicle door lock device.

### BACKGROUND DISCUSSION

Generally, a vehicle door lock device is provided with a latch mechanism which is engaged with a striker provided on a vehicle body. In addition, a door moved to a fully closed position is bound to the vehicle body while being in an unmovable state based on an engagement force of the latch mechanism, for example (for example, refer to JP 2016-108777A).

For example, as illustrated in FIG. 9, a door 71 that is configured as a slide door 70 moving in a vehicle front-rear direction (lateral direction in FIG. 9) is provided with an outer panel 72 that forms an outer surface 71s and an inner panel 73 that is positioned inward of (in FIG. 9, upper side) the outer panel 72. That is, the outer panel 72 and the inner panel 73 extend in the vehicle front-rear direction, which is a door width direction. Furthermore, the inner panel 73 is provided with an end wall portion 73b that extends in a thickness direction (vertical direction in FIG. 9) of the door 71 at an end portion of the inner panel in the door width direction. A reinforcement 74 is provided in the vicinity of the end portion in the width direction at which the end wall portion 73b is provided. In addition, a latch mechanism 75 is disposed between the outer panel 72 and the inner panel 73 with a bracket 80 fixed to the end wall portion 73b of the inner panel 73 in a state where the latch mechanism 75 is held by the bracket 80.

Specifically, as illustrated in FIGS. 9 and 10, the bracket 80 is provided with a base plate 82 having a latch holding portion 81. In addition, the bracket 80 is configured such that the base plate 82 is fixed to the end wall portion 73b of the inner panel 73 in a state where the latch holding portion 81 holds the latch mechanism 75. The base plate 82 is formed with a slit 84 that is open in a closing direction (upper side and right side in FIG. 9) of the door 71 in a state where the base plate 82 is fixed to the door 71.

Specifically, the base plate 82 is provided with a bent portion 83 that extends to intersect the latch holding portion 81. In addition, the slit 84 is provided by cutting a corner portion of the base plate 82 which is provided with the latch holding portion 81 and the bent portion 83 and has an approximately L-shaped section.

That is, the bracket 80 is configured such that a striker 95 provided on a vehicle body 93 side enters the slit 84 of the base plate 82 when the door 71 moves to a fully closed position. In addition, a door lock device 91 is configured such that the latch mechanism 75 supported on the door 71 side is engaged with the striker 95 on the vehicle body 93 side when the striker 95 enters the slit 84.

In addition, the bracket 80 is provided with an extension plate 86 that is fixed to the base plate 82 to extend the bent portion 83. Furthermore, the extension plate 86 is provided with a locking portion 88 of a wire cable 87 that extends from a door handle (not shown) and an open lever 89 that rotates when being pulled by the wire cable 87. The door lock device 91 is configured such that the latch mechanism 75 and the striker 95 are disengaged from each other when the latch mechanism 75 performs an unlatching operation due to the rotation of the open lever 89.

Meanwhile, in the case of a vehicle, securing a higher safety is desirable. Therefore, the above-described door lock device is also required to further contribute to the safety of a vehicle. That is, for example, in a case where a door is pressed from the inside of a vehicle, a load applied in a thickness direction of the door is concentrated to a latch mechanism engaged with a striker on a vehicle body side. Therefore, a portion that supports the latch mechanism on the door is required to have a high support stiffness. Accordingly, there is still room for improvement.

Thus, a need exists for a vehicle door lock device which is not susceptible to the drawback mentioned above.

### SUMMARY

A vehicle door lock device according to an aspect of the disclosure includes a latch mechanism that is engaged with a striker provided on a vehicle body and a bracket that supports the latch mechanism on a door of a vehicle. The bracket includes a base plate that includes a latch holding portion holding the latch mechanism and is fixed to the door, and an extension plate that extends in a direction intersecting the latch holding portion, the extension plate includes a fastening hole for fastening the extension plate to the door in a thickness direction of the door, a first bead-shaped portion that extends in a direction in which the extension plate extends, and a second bead-shaped portion that extends in a direction intersecting the first bead-shaped portion, and a plurality of the first bead-shaped portions and a plurality of the second bead-shaped portions are arranged in a lattice pattern.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view of a door lock device provided for a door (slide door) of a vehicle;

FIG. 2 is a plan view of a latch mechanism (unlatched state);

FIG. 3 is a plan view of the latch mechanism (half-latched state);

FIG. 4 is a plan view of the latch mechanism (fully-latched state);

FIG. 5 is a side view of a bracket holding the latch mechanism (as seen from outer side in thickness direction of door);

FIG. 6 is a side view of the bracket holding the latch mechanism (as seen from inner side in thickness direction of door);

FIG. 7 is a side view of the bracket and latch mechanism fixed to the door (as seen from outer side in thickness direction of door);

FIG. 8 is a sectional view of the door to which the bracket holding the latch mechanism is fixed (section taken along line VIII-VIII in FIG. 6);

FIG. 9 is a sectional view of a door to which a bracket holding a latch mechanism is fixed (related art); and

FIG. 10 is a side view of the bracket holding the latch mechanism (related art) (as seen from outer side in thickness direction of door).

### DETAILED DESCRIPTION

Hereinafter, an embodiment of a door lock device will be described with reference to drawings.

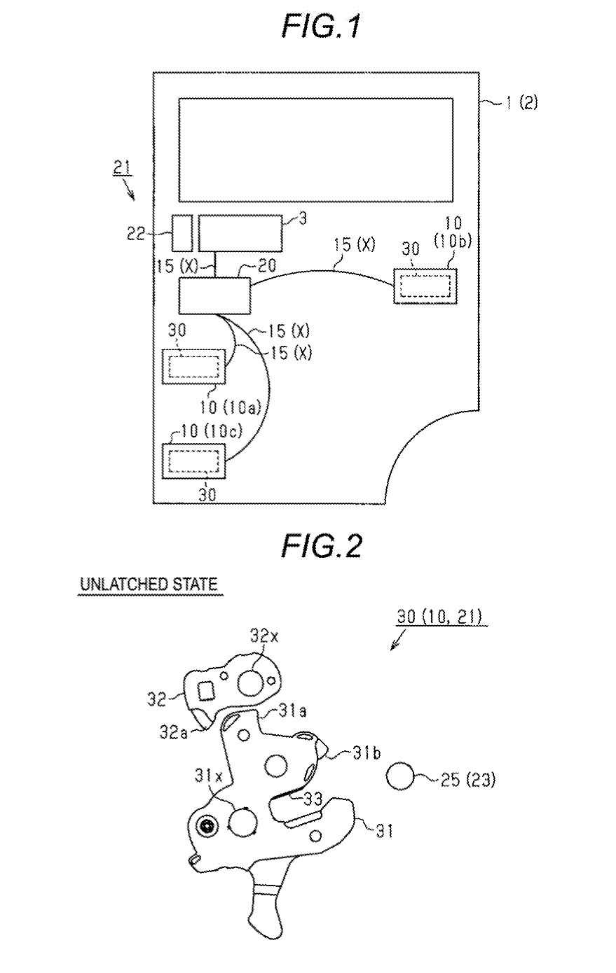

As illustrated in FIG. 1, a door 1 in the present embodiment is configured as a slide door 2, which can open and close a door opening portion provided in a side surface of a vehicle (not shown) by moving in a vehicle front-rear direction. Specifically, the door 1 is configured to enter a fully-closed state, in which the door opening portion is fully closed, when the door 1 moves toward a vehicle front side (left side in FIG. 1) and to enter a fully-open state, in which an occupant can board or alight via the door opening portion, when the door 1 moves toward a vehicle rear side (right side in FIG. 1). In addition, the door 1 is provided with a door handle 3 (outside door handle and inside door handle) which is for opening and closing the door 1.

In addition, the door 1 is provided with lock devices 10 that bind the door 1 to a vehicle body with the door 1 being in an unmovable state. Specifically, the door 1 is provided with a front lock 10a and a rear lock 10b as a fully closing lock that binds the door 1 at a fully closed position. Furthermore, the door 1 is provided with a fully opening lock 10c for binding the door 1 at a fully open position. In addition, each lock device 10 is configured such that it is possible to release the door 1 bound to the vehicle body in an unmovable state by operating the door handle 3.

Specifically, in the case of the door 1 in the present embodiment, each lock device 10 is mechanically connected to the door handle 3 via a transmitting member 15 such as a wire cable or a link. In addition, the door 1 in the present embodiment is configured such that a releasing operation input to the door handle 3 is transmitted to each lock device 10 due to the above-described reason.

In addition, a remote controller (remote control device) 20 that can connect or disconnect (disconnection and reconnection) an operation transmitting system X formed by the transmitting members 15 is provided between the door handle 3 and the lock devices 10. That is, the door 1 enters a locked state (door locked state) in which the door 1 is bound at the fully closed position when a releasing operation input to the door handle 3 becomes not able to be transmitted to each lock device 10 (10a and 10b) constituting the fully closing lock based on an operation of the remote controller 20. In addition, the door locked state ends when the operation transmitting system X enters a connected state again based on an operation of the remote controller 20 (unlocked state). In addition, the vehicle provided with the door 1 is formed with a door lock device 21 for locking and unlocking the door 1 in this manner.

The remote controller 20 in the present embodiment connects or disconnects the operation transmitting system X between the door handle 3 and the lock devices 10 (10a and 10b) constituting the fully closing lock when a lock knob 22 provided inside the door 1 or a cylinder key (not shown) open to the outside of the door 1 is operated. In addition, the remote controller 20 is configured such that it is possible to connect or disconnect the operation transmitting system X by means of an operation input on an operation switch provided in a vehicle cabin, a remote operation which uses wireless communication, or the like as well.

More specifically, as illustrated in FIGS. 2 to 4, each of the lock devices 10 in the present embodiment is provided with a latch mechanism 30 that is engaged with a striker 25 provided on a vehicle body 23 side such that the striker 25 is bound and the striker 25 becomes not able to be separated. In addition, the door 1 is bound to be unmovable based on an engagement force between the latch mechanisms 30 and the strikers 25.

Specifically, each of the latch mechanisms 30 of the present embodiment is provided with a latch 31 and a pawl 32 that can rotate around spindles 31x and 32x, respectively. In the case of the latch mechanism 30 in the present embodiment, the outer shape of the latch 31 is an approximately flat plate-like shape provided with a striker engagement groove 33 that is open at an outer peripheral surface of the striker engagement groove 33. In addition, the latch 31 is urged to rotate in a clockwise direction in each drawing, by a latch urging spring (not shown). Furthermore, the latch 31 abuts onto a stopper portion (not shown) such that rotation based on an urging force of the latch urging spring is restricted at a position where an opening end of the striker engagement groove 33 faces the striker 25 provided on the vehicle body 23 side. In addition, the latch mechanism 30 in the present embodiment is configured such that the striker 25 is engaged with the striker engagement groove 33 of the latch 31 as the door 1 is closed.

Meanwhile, the pawl 32 is urged to rotate in a counter-clockwise direction in each drawing due to a pawl urging spring (not shown). In addition, the pawl 32 in the present embodiment is configured such that a distal end portion 32a thereof comes into slide-contact with the outer peripheral surface of the latch 31 when the pawl 32 rotates based on an urging force of the pawl urging spring. Furthermore, the pawl 32 is configured such that the distal end portion 32a is engaged with the outer peripheral surface of the latch 31 in a state where the striker 25 is engaged with the striker engagement groove 33. In addition, the latch mechanism 30 in the present embodiment is configured such that a state where the striker 25 is engaged with the striker engagement groove 33 of the latch 31 can be maintained due to the above-described reason.

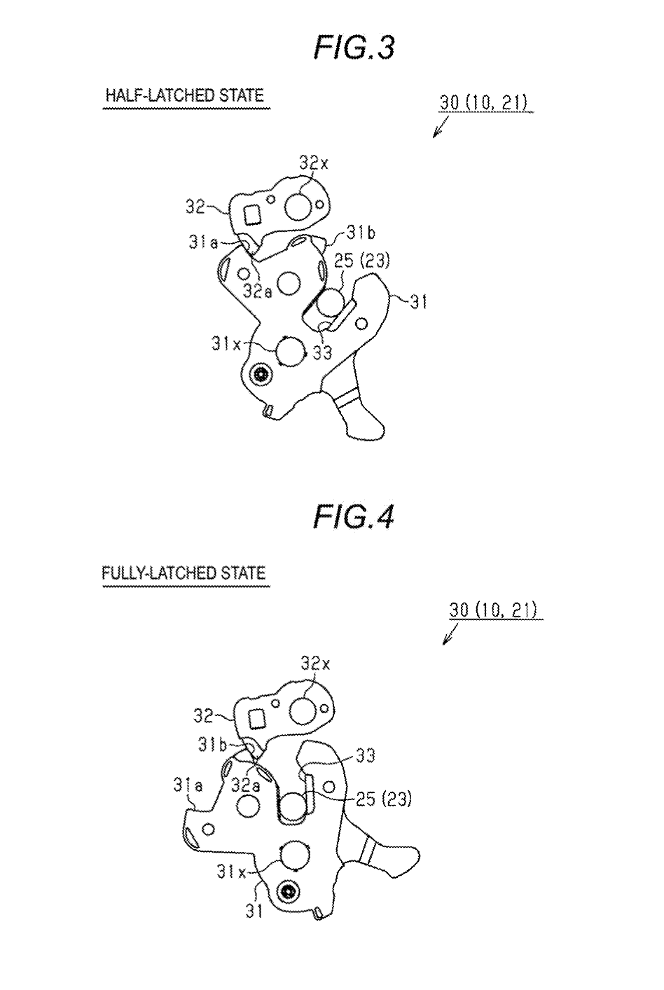

That is, as illustrated in FIGS. 2 and 3, the striker 25 engaged with the striker engagement groove 33 relatively moves toward a deeper side in the striker engagement groove 33 while pressing the latch 31. Accordingly, the latch 31 rotates in the counter-clockwise direction in each drawing against the urging force of the latch urging spring.

In addition, at this time, the distal end portion 32a of the pawl 32 apparently slides on the outer peripheral surface of the latch 31, onto which the distal end portion 32a abuts, in a state where the distal end portion 32a is pressed against the outer peripheral surface of the latch 31 based on the urging force of the pawl urging spring. Furthermore, the distal end portion 32a of the pawl 32 is engaged with a first engagement portion 31a of the latch 31 that is formed on the outer peripheral surface of the latch 31 (half-latched state). In addition, the latch mechanism 30 in the present embodiment is configured such that a state where the striker 25 is engaged with the latch 31 is maintained since rotation of the latch 31 in a direction in which the latch urging spring urges the latch 31 (that is, clockwise direction in each drawing in which striker 25 is discharged from striker engagement groove 33) is restricted (half-latched state).

Furthermore, as illustrated in FIGS. 3 and 4, in the latch mechanism 30 of the present embodiment, the latch 31 can further rotate (in counter-clockwise direction in each drawing) against the urging force of the latch urging spring from a rotation position corresponding to the half-latched state. In addition, the latch mechanism 30 of the present embodiment is configured to transition into a fully-latched state, in which the striker 25 engaged with the striker engagement groove 33 can be more reliably bound with the pawl 32 engaged with a second engagement portion 31b formed on a peripheral surface of the latch 31, when the latch 31 rotates and passes through a half latch position.

In addition, the latch mechanism 30 in the present embodiment is configured such that the pawl 32 rotates in the clockwise direction in each drawing against the urging force of the pawl urging spring when the releasing operation input to the door handle 3 is transmitted to the lock devices 10 via the operation transmitting system X as described above. That is, the pawl 32 is disengaged from the latch 31 and thus the latch 31 rotates in a releasing direction (clockwise direction in each drawing) based on the urging force of the latch urging spring due to the above-described reason. In addition, the lock device 10 in the present embodiment is configured such that the latch mechanism 30 transitions into an unlatched state in which the latch mechanism 30 is not engaged with the striker 25 on the vehicle body 23 side due to the above-described reason and thus the door 1 bound to the vehicle body 23 is released.

### Latch Mechanism Supporting Structure

Next, a structure for supporting the latch mechanism 30 with respect to the door 1 will be described.

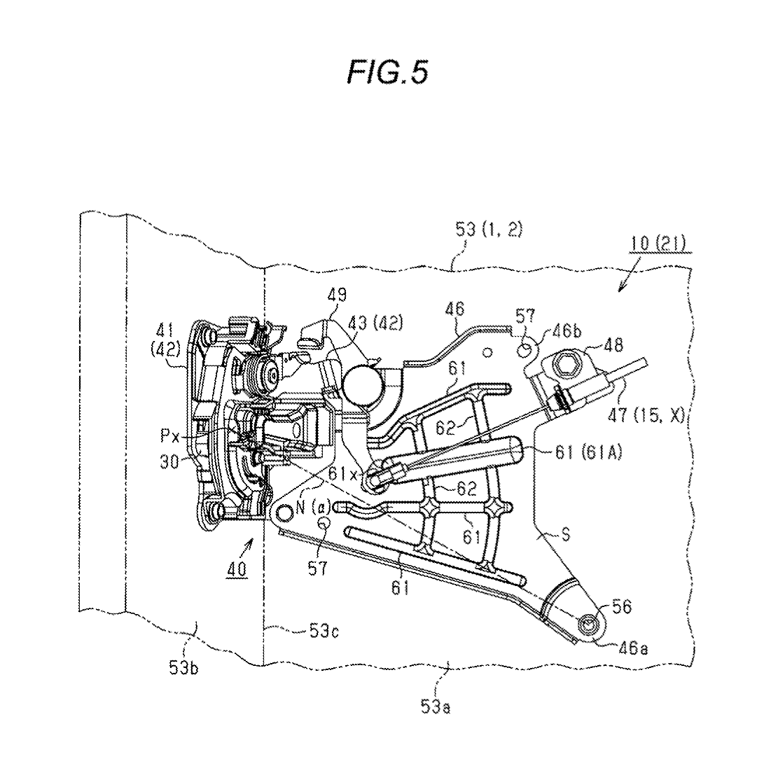

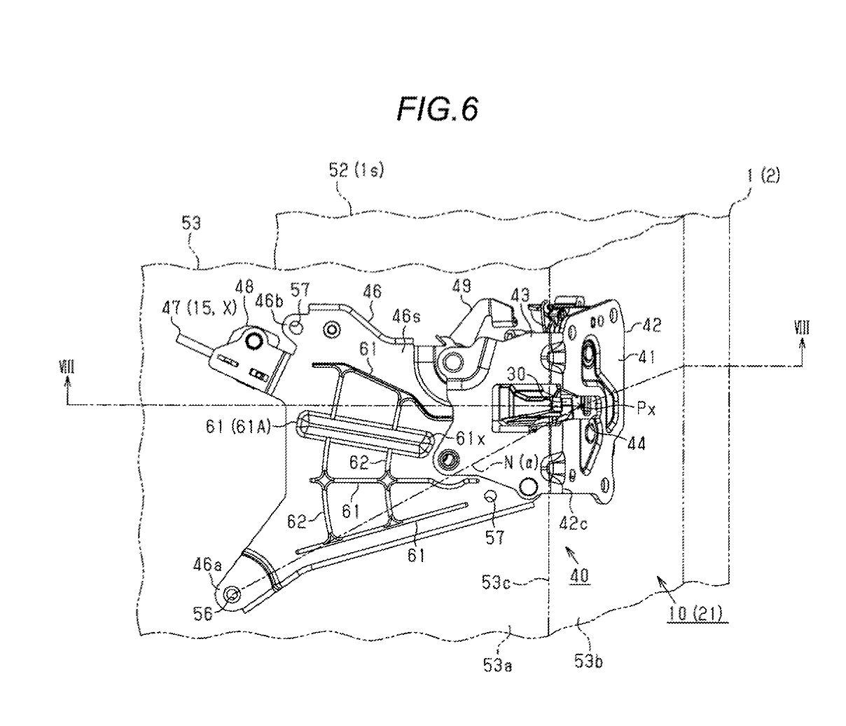

As illustrated in FIGS. 5 and 6, in the door 1 of the present embodiment, each lock device 10 (10a and 10b) constituting the fully closing lock is provided with a bracket 40 that holds the latch mechanism 30. In addition, the latch mechanism 30 is supported on the door 1 with the bracket 40 fixed to the door 1.

Specifically, the bracket 40 in the present embodiment is provided with a base plate 42 having a latch holding portion 41 for holding the latch mechanism 30. In addition, the base plate 42 is provided with a bent portion 43 that extends to intersect the latch holding portion 41. The base plate 42 in the present embodiment is formed through plastic working of a metal plate material. Accordingly, the bent portion 43 of the latch holding portion 41 is formed to have an outer shape with an approximately L-shaped section.

In addition, the base plate 42 is formed with a slit 44 which is formed by cutting a corner portion 42c with an approximately L-shaped section. Furthermore, the bracket 40 in the present embodiment is fixed to the door 1 at a position where the striker 25 provided on the vehicle body 23 side enters the slit 44 when the door 1 moves toward the fully closed position. In addition, the lock device 10 in the present embodiment is configured such that the latch mechanism 30 that is supported on the door 1 side via the bracket 40 is engaged with the striker 25 on the vehicle body 23 side.

Furthermore, the bracket 40 in the present embodiment is provided with an extension plate 46 that extends in a direction intersecting the latch holding portion 41 by being fixed to the base plate 42 to extend the bent portion 43. In addition, the extension plate 46 is provided with a locking portion 48 of a wire cable 47 constituting the operation transmitting system X and an open lever 49 that rotates when being pulled by the wire cable 47. In addition, the lock device 10 in the present embodiment is configured such that the latch mechanism 30 performs an unlatching operation based on rotation of the open lever 49.

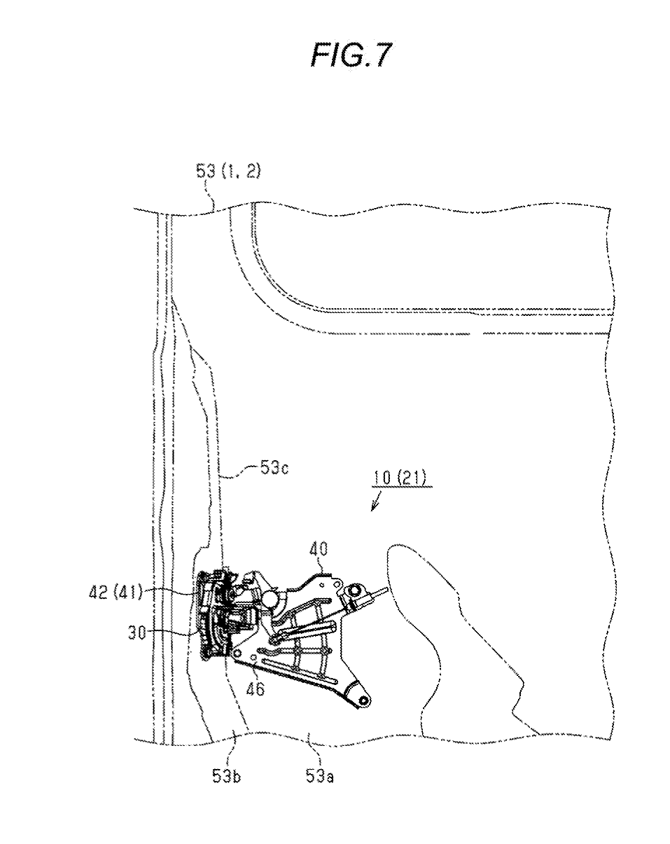

More specifically, as illustrated in FIGS. 5 to 8, the door 1 is provided with an outer panel 52 constituting an outer surface 1s and an inner panel 53 that is positioned inward of the outer panel 52. In addition, the lock device 10 in the present embodiment is configured such that the bracket 40 is fixed to the inner panel 53 of the door 1 from an outer side in a vehicle width direction and is disposed between the outer panel 52 and the inner panel 53.

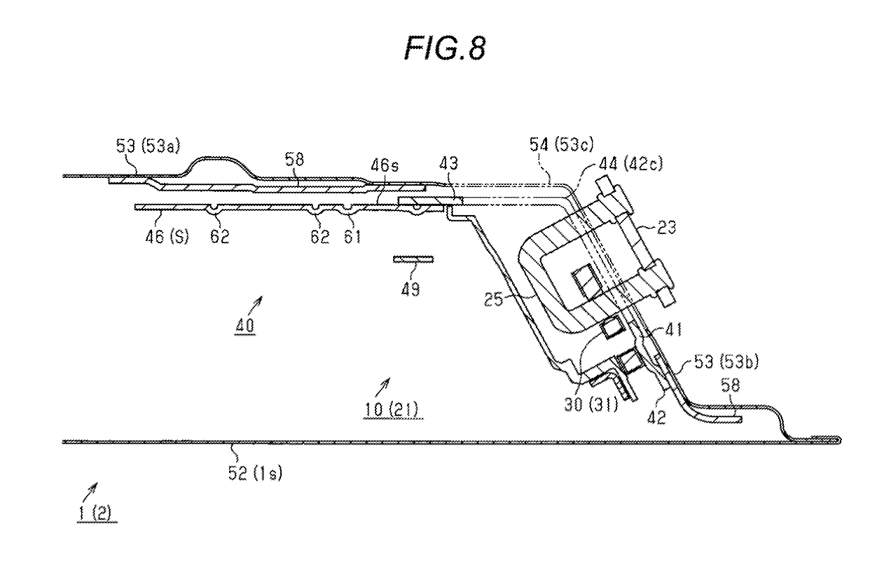

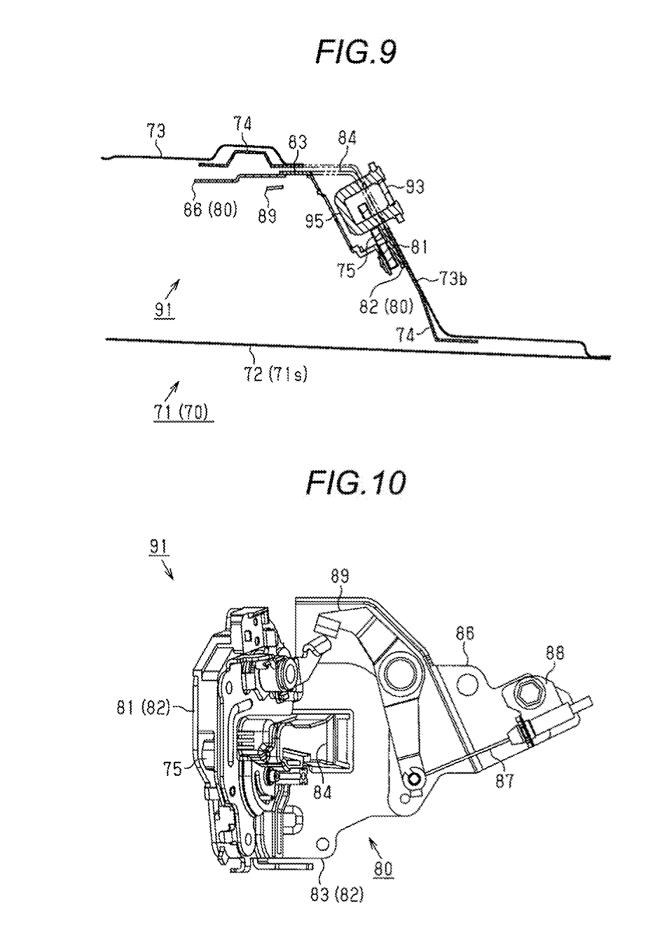

In the door 1 of the present embodiment, the inner panel 53 is provided with a main body portion 53a that is disposed to be approximately parallel to the outer panel 52 extending in a door width direction of the door 1 configured as the slide door 2 (that is, in the vehicle front-rear direction (lateral direction in each drawing)) and an end wall portion 53b that extends in a thickness direction (vertical direction in FIG. 8) of the door 1 at an end portion in the door width direction. Furthermore, a corner portion 53c of the inner panel 53 at which the main body portion 53a and the end wall portion 53b intersect each other is provided with a slit-shaped opening portion 54. In addition, the lock device 10 in the present embodiment is configured such that the bracket 40 is fixed to the inner panel 53 at a position where the slit 44 formed in the base plate 42 that constitutes the bracket 40 overlaps the opening portion 54 provided in the inner panel 53.

Specifically, in the case of the bracket 40 in the present embodiment, the latch holding portion 41 provided for the base plate 42 is fixed to the end wall portion 53b of the inner panel 53. In addition, the bracket 40 in the present embodiment is configured such that the extension plate 46 extending in a direction intersecting the latch holding portion 41 of the base plate 42 fixed to the end wall portion 53b of the inner panel 53 is disposed along the main body portion 53a of the inner panel 53. Furthermore, an end portion 46a of the extension plate 46, which is separated from the latch holding portion 41 of the base plate 42 in a direction in which the extension plate 46 extends (that is, vehicle front-rear direction) is provided with a fastening hole 56 into which a fastening member (bolt) (not shown) is inserted. In addition, the bracket 40 of the present embodiment is configured such that the extension plate 46 is fixed to the main body portion 53a of the inner panel 53 in a thickness direction of the door 1 by means of the fastening hole 56.

In the door 1 of the present embodiment, a portion at which the bracket 40 is fixed to the inner panel 53 is provided with a reinforcement 58. In addition, the door 1 of the present embodiment is configured such that the strength of a portion supporting the latch mechanism 30 via the bracket 40 is secured due to the above-described reason.

In addition, as illustrated in FIGS. 5 and 6, the extension plate 46 in the present embodiment is provided with hole portions 57 for temporary assembly. Specifically, regarding the extension plate 46 of the present embodiment, the hole portions 57 for temporary assembly are provided in an end portion 46b, which is separated from the end portion 46a provided with the fastening hole 56 in a direction (vertical direction in each drawing) intersecting the direction in which the extension plate 46 extends, and in a portion of the extension plate 46 that is close to a portion connected to the bent portion 43 of the base plate 42. Furthermore, by means of the hole portions 57 for temporary assembly, the bracket 40 in the present embodiment is locked onto the main body portion 53a of the inner panel 53 in a state where the end portion 46a of the extension plate 46 provided with the fastening hole 56 faces a lower side of the vehicle (lower side in each drawing). In addition, in this state, the extension plate 46 is fixed to the main body portion 53a of the inner panel 53 and the base plate 42 is fixed to the end wall portion 53b of the inner panel 53.

More specifically, in the bracket 40 of the present embodiment, the extension plate 46 is formed with a plurality of bead-shaped portions (first bead-shaped portions 61), each of which has a curved section (that is, portion having bead-like shape) and extends in the direction in which the extension plate 46 extending in the vehicle front-rear direction along the main body portion 53a of the inner panel 53 extends. Furthermore, the extension plate 46 is formed with a plurality of bead shaped portions (second bead-shaped portions 62), each of which extends in a direction intersecting the direction in which the extension plate 46 extends (that is, vehicle height direction). In addition, the extension plate 46 in the present embodiment is configured such that the first and second bead-shaped portions 61 and 62 are arranged in a lattice pattern.

Specifically, the extension plate 46 in the present embodiment is provided with four first bead-shaped portions 61 and two second bead-shaped portions 62. In addition, each of the first and second bead-shaped portions 61 and 62 has a bead-like shape that protrudes toward a side opposite to a fixation surface 46s of the extension plate 46 with respect to the main body portion 53a of the inner panel 53, that is, toward a side close to a surface S of the extension plate 46 provided with the locking portion 48 of the wire cable 47 and the open lever 49 (refer to FIG. 8). In addition, the bracket 40 in the present embodiment is configured such that the stiffness of the extension plate 46 is increased with formation of the first and second bead-shaped portions 61 and 62.

In addition, regarding the extension plate 46 of the present embodiment, one (61A) of the four first bead-shaped portions 61 that is positioned on a central portion of the extension plate 46 in a direction (vertical direction in each drawing) intersecting the direction in which the extension plate 46 extends has a bead-like shape thicker than those of the other first bead-shaped portions 61 and the second bead-shaped portions 62. In other words, the first bead-shaped portion 61A having a thick bead-like shape is positioned on an approximately central portion of the extension plate 46 in the vehicle height direction in a state where the bracket 40 is fixed to the inner panel 53, the extension plate 46 extending in the vehicle front-rear direction. Furthermore, a longitudinal end portion 61x of the first bead-shaped portion 61A having the thick bead-like shape is in a region a, in which a straight line N connecting a position Px at which the latch mechanism 30 is engaged with the striker 25 on the vehicle body 23 side as described above and the fastening hole 56 provided in the end portion 46a of the extension plate 46 is formed. In addition, the bracket 40 in the present embodiment is configured such that a higher stiffness is given to the extension plate 46 due to the above-described reason.

Next, the operation and effect of the present embodiment will be described.

(1) In the door 1 of the vehicle, each lock device 10 (10a and 10b) constituting the door lock device 21 is provided with the latch mechanism 30 that is engaged with the striker 25 provided on the vehicle body 23 side and the bracket 40 that supports the latch mechanism 30 on the door 1 of the vehicle. In addition, the bracket 40 is provided with the base plate 42 that is provided with the latch holding portion 41 holding the latch mechanism 30 and is fixed to the door 1 and the extension plate 46 that extends in a direction intersecting the latch holding portion 41. Furthermore, the extension plate 46 is provided with the fastening hole 56 for fastening the extension plate 46 to the door 1 in the thickness direction of the door 1, the plurality of first bead-shaped portions 61 that extend in the direction in which the extension plate 46 extends, and the plurality of second bead-shaped portions 62 that extend in a direction intersecting the first bead-shaped portions 61. In addition, the extension plate 46 has a structure in which the first and second bead-shaped portions 61 and 62 are arranged in a lattice pattern.

According to the above-described configuration, a load applied to the door 1 in the thickness direction can be received by the extension plate 46 fixed to the door 1 in the thickness direction in a case where the door 1 is pressed from a vehicle cabin side, for example. Furthermore, since the first and second bead-shaped portions that extend in the direction in which the extension plate 46 extends and the direction intersecting the direction in which the extension plate 46 extends are arranged in a lattice pattern on the extension plate 46, the stiffness of the extension plate 46 can be effectively increased. Accordingly, even in a case where an excessive load is applied in the thickness direction of the door 1, deformation of a portion supporting the latch mechanism 30 is suppressed and thus a higher safety can be secured.

(2) The fastening hole 56 is provided in the end portion 46a of the extension plate 46 that is separated from the latch holding portion 41 provided on the base plate 42 in the direction in which the extension plate 46 extends. Accordingly, a load applied to the door 1 in the thickness direction can be effectively received by the extension plate 46.

(3) A bead-like shape of at least one (61A) of the first bead-shaped portions 61 provided on the extension plate 46, which is positioned on the central portion of the extension plate 46 in the direction intersecting the direction in which the extension plate 46 extends, is set to be thicker than the other first bead-shaped portions 61 and the second bead-shaped portions 62. Accordingly, it is possible to more effectively increase the stiffness of the extension plate 46 while suppressing a dimension of the extension plate 46 in the thickness direction of the door 1.

(4) The longitudinal end portion 61x of the first bead-shaped portion 61A having a thick bead-like shape is in the region a, in which the straight line N connecting the position Px at which the latch mechanism 30 is engaged with the striker 25 on the vehicle body 23 side and the fastening hole 56 provided in the extension plate 46 is formed.

That is, due to a load applied to the door 1 in the thickness direction, a force that bends the extension plate 46 acts on the extension plate 46 in a direction connecting the position Px at which the latch mechanism 30 held by the base plate 42 is engaged with the striker 25 and the fastening hole 56 forming a fixation portion of the extension plate 46 with respect to the door 1. However, according to the above-described configuration, it is possible to effectively increase the stiffness of the extension plate 46 corresponding to a force acting on the extension plate 46 as described above.

(5) Each of the first and second bead-shaped portions 61 and 62 has a bead-like shape that protrudes toward a side opposite to the fixation surface 46s of the extension plate 46 with respect to the door 1. According to the above-described configuration, it is possible to reduce a space that is occupied by the extension plate 46 in a state where the extension plate 46 is fixed to the door 1.

The above-described embodiment can be implemented by being modified as follows. The above-described embodiment and the following modification example can be implemented by being combined with each other as long as there is no technical conflict.
In the above-described embodiment, the door 1 has a configuration as the slide door 2 which can open and close the door opening portion provided in the side surface of the vehicle by moving in the vehicle front-rear direction. However, the door 1 may be embodied as a supporting structure for a latch mechanism that constitutes a door lock device in another type of a vehicle door such as a swing door or a back door.
In the above-described embodiment, the extension plate 46 is provided with four first bead-shaped portions 61 and two second bead-shaped portions 62. However, the number of first and second bead-shaped portions 61 and 62 may be randomly changed.
Furthermore, the number of first bead-shaped portions 61A of which a bead-like shape is set to be thicker than the other first bead-shaped portions 61 and the second bead-shaped portions 62 and a setting position of the first bead-shaped portion 61A may also be randomly changed.
A configuration of the latch mechanism 30 held by the bracket 40 may be randomly changed. In addition, the outer shape (contour) of the extension plate 46 may also be randomly changed.
In the above-described embodiment, the extension plate 46 of the bracket 40 is fixed to the bent portion 43 of the base plate 42 that has an outer shape with an approximately L-shaped section. Accordingly, the extension plate 46 extends in a direction intersecting the latch holding portion 41 of the base plate 42. However, the disclosure is not limited to this. For example, the extension plate 46 may be integrally formed with the latch holding portion 41 of the base plate 42 through plastic working of a metal plate material or the like.

A vehicle door lock device according to an aspect of the disclosure includes a latch mechanism that is engaged with a striker provided on a vehicle body and a bracket that supports the latch mechanism on a door of a vehicle. The bracket includes a base plate that includes a latch holding portion holding the latch mechanism and is fixed to the door, and an extension plate that extends in a direction intersecting the latch holding portion, the extension plate includes a fastening hole for fastening the extension plate to the door in a thickness direction of the door, a first bead-shaped portion that extends in a direction in which the extension plate extends, and a second bead-shaped portion that extends in a direction intersecting the first bead-shaped portion, and a plurality of the first bead-shaped portions and a plurality of the second bead-shaped portions are arranged in a lattice pattern.

According to the configuration described above, a load applied to the door in the thickness direction can be received by the extension plate fixed to the door in the thickness direction in a case where the door is pressed from a vehicle cabin side, for example. Furthermore, since the first and second bead-shaped portions that extend in the direction in which the extension plate extends and the direction intersecting the direction in which the extension plate extends are arranged in a lattice pattern on the extension plate, the stiffness of the extension plate can be effectively increased. Accordingly, even in a case where an excessive load is applied in the thickness direction of the door, deformation of a portion supporting the latch mechanism is suppressed and thus a higher safety can be secured.

In the vehicle door lock device, it is preferable that the fastening hole is provided in an end portion of the extension plate that is separated from the latch holding portion in the direction in which the extension plate extends.

According to the configuration described above, a load applied to the door in the thickness direction can be effectively received by the extension plate.

In the vehicle door lock device, it is preferable that a bead-like shape of at least one of the first bead-shaped portions is set to be thicker than the other first bead-shaped portions and the second bead-shaped portions.

According to the configuration described above, it is possible to more effectively increase the stiffness of the extension plate while suppressing a dimension of the extension plate in the thickness direction of the door.

In the vehicle door lock device, it is preferable that a shape of the first bead-shaped portion that is positioned on a central portion of the extension plate in a direction intersecting the direction in which the extension plate extends is set to be the thick bead-like shape.

According to the configuration described above, it is possible to more effectively increase the stiffness of the extension plate.

In the vehicle door lock device, it is preferable that a shape of the first bead-shaped portion whose longitudinal end portion positions in a region in which a straight line connecting a position at which the latch mechanism is engaged with the striker and the fastening hole is formed is set to be the thick bead-like shape.

That is, due to a load applied to the door in the thickness direction, a force that bends the extension plate acts on the extension plate in a direction connecting the position at which the latch mechanism held by the base plate is engaged with the striker and the fastening hole forming a fixation portion of the extension plate with respect to the door. However, according to the above-described configuration, it is possible to effectively increase the stiffness of the extension plate corresponding to a force acting on the extension plate as described above.

In the vehicle door lock device, it is preferable that each of the first and second bead-shaped portions has a bead-like shape that protrudes toward a side opposite to a fixation surface of the extension plate with respect to the door.

According to the configuration described above, it is possible to reduce a space that is occupied by the extension plate in a state where the extension plate is fixed to the door.

According to the aspect of this disclosure, it is possible to secure a higher support stiffness for a latch mechanism.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock device comprising:
a latch mechanism that is engaged with a striker provided on a vehicle body; and
a bracket that supports the latch mechanism on a door of a vehicle,
wherein the bracket includes
a base plate that includes a latch holding portion holding the latch mechanism and is fixed to the door, and
an extension plate that extends in a direction intersecting the latch holding portion,
the extension plate includes
a fastening hole for fastening the extension plate to the door in a thickness direction of the door,
a first bead-shaped portion that extends in a direction in which the extension plate extends, and
a second bead-shaped portion that extends in a direction intersecting the first bead-shaped portion, and
a plurality of the first bead-shaped portions and a plurality of the second bead-shaped portions are arranged in a lattice pattern.

2. The vehicle door lock device according to claim 1,
wherein the fastening hole is provided in an end portion of the extension plate that is separated from the latch holding portion in the direction in which the extension plate extends.

3. The vehicle door lock device according to claim 1,
wherein a bead-like shape of at least one of the first bead-shaped portions is set to be thicker than the other first bead-shaped portions and the second bead-shaped portions.

4. The vehicle door lock device according to claim 2,
wherein a bead-like shape of at least one of the first bead-shaped portions is set to be thicker than the other first bead-shaped portions and the second bead-shaped portions.

5. The vehicle door lock device according to claim 3,
wherein a shape of the first bead-shaped portion that is positioned on a central portion of the extension plate in a direction intersecting the direction in which the extension plate extends is set to be the thick bead-like shape.

6. The vehicle door lock device according to claim 4,
wherein a shape of the first bead-shaped portion that is positioned on a central portion of the extension plate in a direction intersecting the direction in which the extension plate extends is set to be the thick bead-like shape.

7. The vehicle door lock device according to claim 3,
wherein a shape of the first bead-shaped portion whose longitudinal end portion positions in a region in which a straight line connecting a position at which the latch mechanism is engaged with the striker and the fastening hole is formed is set to be the thick bead-like shape.

8. The vehicle door lock device according to claim 4,
wherein a shape of the first bead-shaped portion whose longitudinal end portion positions in a region in which a straight line connecting a position at which the latch mechanism is engaged with the striker and the fastening hole is formed is set to be the thick bead-like shape.

9. The vehicle door lock device according to claim 5,
wherein a shape of the first bead-shaped portion whose longitudinal end portion positions in a region in which a straight line connecting a position at which the latch mechanism is engaged with the striker and the fastening hole is formed is set to be the thick bead-like shape.

10. The vehicle door lock device according to claim 6,
wherein a shape of the first bead-shaped portion whose longitudinal end portion positions in a region in which a straight line connecting a position at which the latch mechanism is engaged with the striker and the fastening hole is formed is set to be the thick bead-like shape.

11. The vehicle door lock device according to claim 1,
wherein each of the first and second bead-shaped portions has a bead-like shape that protrudes toward a side opposite to a fixation surface of the extension plate with respect to the door.

12. The vehicle door lock device according to claim 2,
wherein each of the first and second bead-shaped portions has a bead-like shape that protrudes toward a side opposite to a fixation surface of the extension plate with respect to the door.

13. The vehicle door lock device according to claim 3,
wherein each of the first and second bead-shaped portions has a bead-like shape that protrudes toward a side opposite to a fixation surface of the extension plate with respect to the door.

14. The vehicle door lock device according to claim 5,
wherein each of the first and second bead-shaped portions has a bead-like shape that protrudes toward a side opposite to a fixation surface of the extension plate with respect to the door.

15. The vehicle door lock device according to claim 7,
wherein each of the first and second bead-shaped portions has a bead-like shape that protrudes toward a side opposite to a fixation surface of the extension plate with respect to the door.
